(19) United States
(12) Patent Application Publication
(10) Pub. No.: US 2026/0055711 A1
(43) Pub. Date: Feb. 26, 2026

(54) TURBINE AND TURBOCHARGER

(71) Applicant: IHI Corporation, Tokyo (JP)

(72) Inventors: Koji SAKOTA, Tokyo (JP); Kenichi SEGAWA, Tokyo (JP)

(73) Assignee: IHI Corporation, Tokyo (JP)

(21) Appl. No.: 19/372,477

(22) Filed: Oct. 29, 2025

Related U.S. Application Data
(63) Continuation of application No. PCT/JP2024/021510, filed on Jun. 13, 2024.

(30) Foreign Application Priority Data
Sep. 8, 2023 (JP) 2023-145938

(51) Int. Cl. F01D 9/04

(52) U.S. Cl. CPC F01D 9/041; F05D 2220/40; F05D 2240/128; F05D 2240/14

(57) ABSTRACT

Provided is a turbine including: a turbine impeller; a plurality of nozzle vanes that are placed on a radially outer side with respect to the turbine impeller so as to be spaced apart from each other in a circumferential direction of the turbine impeller, and are each provided so as to be pivotable about a pivot axis extending along an axial direction of the turbine impeller; a first annular member and a second annular member that extend in the circumferential direction and sandwich the plurality of nozzle vanes from both sides in the axial direction; and at least one groove that is formed in a surface opposed to the plurality of nozzle vanes in at least one of the first annular member or the second annular member, and extends in a direction inclined with respect to the circumferential direction.

### CROSS REFERENCE TO RELATED APPLICATIONS

This application is a continuation application of International Application No. PCT/JP2024/021510, filed on June 13, 2024, which claims priority to Japanese Patent Application No. 2023-145938, filed on September 8, 2023, the entire contents of which are incorporated by reference herein.

### BACKGROUND ART

### Technical Field

The present disclosure relates to a turbine and a turbocharger. The present application claims the benefit of priority to Japanese Patent Application No. 2023-145938 filed on September 8, 2023, the contents of which are incorporated herein by reference.

### Related Art

In a turbine used for a turbocharger or the like, in some cases, a nozzle vane for adjusting the flow velocity of an exhaust gas is provided. For example, as disclosed in Patent Literature 1, a plurality of nozzle vanes are placed on a radially outer side with respect to a turbine impeller so as to be spaced apart from each other in a circumferential direction of the turbine impeller. The cross-sectional area of a flow passage formed between nozzle vanes that are adjacent to each other changes as each nozzle vane pivots. In this manner, the flow velocity of the exhaust gas flowing between the nozzle vanes that are adjacent to each other changes.

### Citation List

### Patent Literature

Patent Literature: JP 2004-116313 A

### SUMMARY

### Technical Problem

Each nozzle vane is sandwiched by two annular members in an axial direction of the turbine impeller. In some cases, a foreign matter enters a space between the nozzle vane and the annular member. Such entrance of a foreign matter may become a factor that inhibits a smooth operation of the nozzle vane.

The present disclosure has an object to provide a turbine and a turbocharger that are capable of removing a foreign matter.

### Solution to Problem

In order to solve the above-mentioned problem, according to the present disclosure, there is provided a turbine including: a turbine impeller; a plurality of nozzle vanes that are placed on a radially outer side with respect to the turbine impeller so as to be spaced apart from each other in a circumferential direction of the turbine impeller, and are each provided so as to be pivotable about a pivot axis extending along an axial direction of the turbine impeller; a first annular member and a second annular member that extend in the circumferential direction and sandwich the plurality of nozzle vanes from both sides in the axial direction; and at least one groove that is formed in a surface opposed to the plurality of nozzle vanes in at least one of the first annular member or the second annular member, and extends in a direction inclined with respect to the circumferential direction.

When viewed in the axial direction, the at least one groove may extend along an outer edge of a corresponding one of the plurality of nozzle vanes when an opening degree of the corresponding one of the plurality of nozzle vanes is a specific opening degree.

When viewed in the axial direction, the at least one groove may intersect with a corresponding one of the plurality of nozzle vanes regardless of an opening degree of the corresponding one of the plurality of nozzle vanes.

The at least one groove may extend from an inner peripheral edge to an outer peripheral edge of the surface.

The turbine may further include a third annular member that is provided on a side opposite to the plurality of nozzle vanes with respect to the second annular member, extends in the circumferential direction, and is provided so as to be pivotable in conjunction with the plurality of nozzle vanes. The at least one groove may be formed in at least the first annular member.

The turbine may further include a third annular member that is provided on a side opposite to the plurality of nozzle vanes with respect to the second annular member, extends in the circumferential direction, and is provided so as to be pivotable in conjunction with the plurality of nozzle vanes. The at least one groove may be formed in at least the second annular member.

In order to solve the above-mentioned problem, according to the present disclosure, there is provided a turbocharger including the above-mentioned turbine.

### Effects

According to the present disclosure, a foreign matter can be removed.

### BRIEF DESCRIPTION OF DRAWINGS

FIG. 1 is a schematic cross-sectional view of a turbocharger according to an embodiment of the present disclosure.

FIG. 2 is a view of a first region extracted from FIG. 1.

FIG. 3 is a view of a drive ring in the embodiment as viewed from a bearing housing side.

FIG. 4 is a view of a second region extracted from FIG. 1.

FIG. 5 is a view of a shroud ring in the embodiment as viewed from the bearing housing side.

FIG. 6 is a view of a shroud ring in a modification example as viewed from the bearing housing side.

### DESCRIPTION OF EMBODIMENTS

Now, one embodiment of the present disclosure is described with reference to the attached drawings. Dimensions, materials, and other specific numerical values shown in the embodiment are merely examples for facilitating the understanding, and do not limit the present disclosure unless otherwise specified. In the present specification and the drawings, elements having substantially the same functions and configurations are denoted by the same reference symbols, and thus redundant description thereof is omitted. Further, illustration of elements not directly related to the present disclosure is omitted.

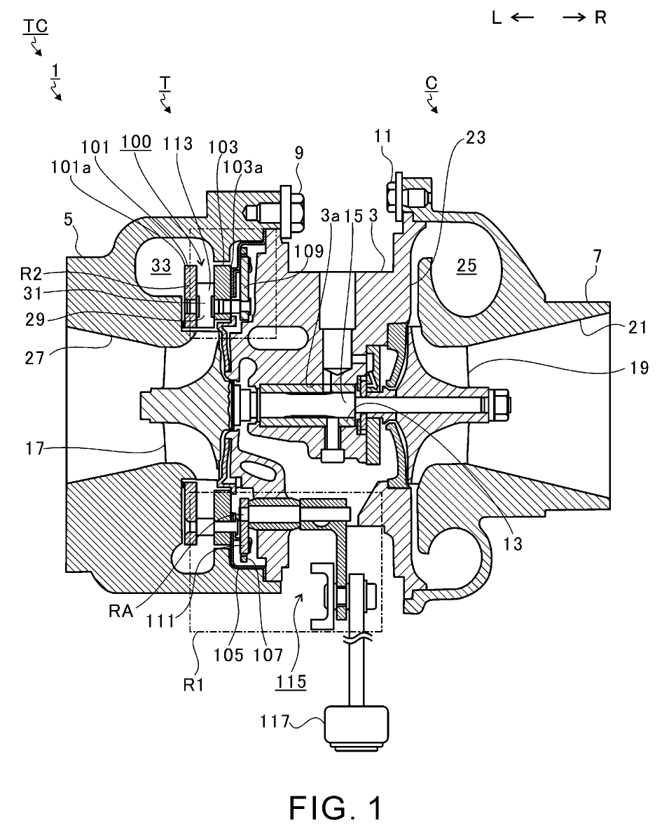

FIG. 1 is a schematic cross-sectional view of a turbocharger TC according to this embodiment. In the following, description is given assuming that a direction indicated by the arrow L illustrated in FIG. 1 corresponds to a left side of the turbocharger TC. Description is given assuming that a direction indicated by the arrow R illustrated in FIG. 1 corresponds to a right side of the turbocharger TC. As illustrated in FIG. 1, the turbocharger TC includes a turbocharger main body 1. The turbocharger main body 1 includes a bearing housing 3, a turbine housing 5, and a compressor housing 7.

The turbine housing 5 is coupled to a left side of the bearing housing 3 by a fastening bolt 9. The compressor housing 7 is coupled to a right side of the bearing housing 3 by a fastening bolt 11. The turbocharger TC includes a turbine T and a centrifugal compressor C. The turbine T includes the bearing housing 3 and the turbine housing 5. The centrifugal compressor C includes the bearing housing 3 and the compressor housing 7.

A bearing hole 3a is formed in the bearing housing 3. The bearing hole 3a penetrates the bearing housing 3 in a left-right direction of the turbocharger TC. A bearing 13 is placed in the bearing hole 3a. FIG. 1 shows a semi-floating bearing as an example of the bearing 13. However, the bearing 13 may be another bearing such as a full-floating bearing or a rolling bearing. The bearing 13 axially supports a shaft 15 in a rotatable manner. A turbine impeller 17 is provided at a left end portion of the shaft 15. The turbine impeller 17 is accommodated in the turbine housing 5 so as to be rotatable. A compressor impeller 19 is provided at a right end portion of the shaft 15. The compressor impeller 19 is accommodated in the compressor housing 7 so as to be rotatable. The turbine impeller 17 and the compressor impeller 19 rotate integrally with the shaft 15.

An axial direction, a radial direction, and a circumferential direction of the turbocharger TC are hereinafter also simply referred to as "axial direction," "radial direction," and "circumferential direction," respectively. The axial direction of the turbocharger TC corresponds to an axial direction of the shaft 15, an axial direction of the turbine impeller 17, and an axial direction of the compressor impeller 19. The radial direction of the turbocharger TC corresponds to a radial direction of the shaft 15, a radial direction of the turbine impeller 17, and a radial direction of the compressor impeller 19. The circumferential direction of the turbocharger TC corresponds to a circumferential direction of the shaft 15, a circumferential direction of the turbine impeller 17, and a circumferential direction of the compressor impeller 19.

An intake port 21 is formed in the compressor housing 7. The intake port 21 opens on the right side of the turbocharger TC. The intake port 21 is connected to an air cleaner (not shown). A diffuser flow passage 23 is formed between the bearing housing 3 and the compressor housing 7. The diffuser flow passage 23 increases the pressure of air. The diffuser flow passage 23 extends in the circumferential direction and is formed in an annular shape. The diffuser flow passage 23 communicates with the intake port 21 on a radially inner side through intermediation of a space in which the compressor impeller 19 is placed.

A compressor scroll flow passage 25 is formed in the compressor housing 7. The compressor scroll flow passage 25 extends in the circumferential direction and is formed in an annular shape. The compressor scroll flow passage 25 is located, for example, on a radially outer side with respect to the compressor impeller 19. The compressor scroll flow passage 25 communicates with an intake port of an engine (not shown) and the diffuser flow passage 23.

When the compressor impeller 19 rotates, air is sucked into the compressor housing 7 from the intake port 21. The sucked air is pressurized and accelerated in the process of flowing through blades of the compressor impeller 19. The air having been pressurized and accelerated is increased in pressure in the diffuser flow passage 23 and the compressor scroll flow passage 25. The air having been increased in pressure flows out from a discharge port (not shown) and is guided to the intake port of the engine.

An exhaust port 27 is formed in the turbine housing 5. The exhaust port 27 opens on the left side of the turbocharger TC. The exhaust port 27 is connected to an exhaust gas purification device (not shown). A clearance 29 is formed between the bearing housing 3 and the turbine housing 5. A flow passage 31 through which an exhaust gas flows is formed in the clearance 29. The flow passage 31 extends in the circumferential direction and is formed in an annular shape.

A turbine scroll flow passage 33 is formed in the turbine housing 5. The turbine scroll flow passage 33 is located, for example, on the radially outer side with respect to the turbine impeller 17. The flow passage 31 is located between the turbine impeller 17 and the turbine scroll flow passage 33. The flow passage 31 allows the turbine scroll flow passage 33 and the exhaust port 27 to communicate with each other through intermediation of a space in which the turbine impeller 17 is placed.

The turbine scroll flow passage 33 communicates with a gas inflow port (not shown). An exhaust gas discharged from an exhaust manifold of the engine (not shown) is guided to the gas inflow port. The exhaust gas guided from the gas inflow port to the turbine scroll flow passage 33 is guided to the exhaust port 27 via the flow passage 31 and the blades of the turbine impeller 17. The exhaust gas guided to the exhaust port 27 in the process of flowing causes the turbine impeller 17 to rotate.

The rotational force of the turbine impeller 17 is transmitted to the compressor impeller 19 through the shaft 15. As described above, the air is increased in pressure by the rotational force of the compressor impeller 19 and is guided to the intake port of the engine.

When a flow rate of the exhaust gas introduced to the turbine housing 5 becomes smaller, a rotation amount of the turbine impeller 17 becomes smaller. When the rotation amount of the turbine impeller 17 becomes smaller, a rotation amount of the compressor impeller 19 also becomes smaller. When the rotation amount of the compressor impeller 19 becomes smaller, it may not be possible to sufficiently increase the pressure of the air to be supplied to the intake port of the engine.

In the turbine housing 5, a variable capacity mechanism 100 is provided in the clearance 29. The variable capacity mechanism 100 changes a flow passage cross-sectional area of the flow passage 31 depending on the flow rate of the exhaust gas. For example, the variable capacity mechanism 100 reduces the flow passage cross-sectional area of the flow passage 31 when the number of revolutions of the engine is low and the flow rate of the exhaust gas is small.

When the flow passage cross-sectional area of the flow passage 31 becomes smaller, the flow velocity of the exhaust gas passing through the flow passage 31 becomes faster as compared to a case in which the flow passage cross-sectional area of the flow passage 31 is large. When the flow velocity of the exhaust gas becomes faster, the rotation amount of the turbine impeller 17 becomes larger. When the rotation amount of the turbine impeller 17 becomes larger, the rotation amount of the compressor impeller 19 also becomes larger. When the rotation amount of the compressor impeller 19 becomes larger, the pressure of the air to be supplied to the intake port of the engine can be sufficiently increased. In this way, the variable capacity mechanism 100 can increase the rotation amounts of the turbine impeller 17 and the compressor impeller 19 when the flow rate of the exhaust gas is small. In the following, details of the variable capacity mechanism 100 are described.

The variable capacity mechanism 100 includes a shroud ring 101, a nozzle ring 103, a retaining member 105, a drive ring 107, a transmitting link 109, a link plate 111, a plurality of nozzle vanes 113, a drive mechanism 115, and an actuator 117. The shroud ring 101 and the nozzle ring 103 correspond to examples of a first annular member and a second annular member, respectively, that sandwich the plurality of nozzle vanes 113 from both sides in the axial direction.

The shroud ring 101 is placed on a side of the clearance 29 that is farther from the bearing housing 3. The nozzle ring 103 is placed on a side of the clearance 29 that is closer to the bearing housing 3. The shroud ring 101 is placed so as to be opposed to the nozzle ring 103 in the axial direction. The shroud ring 101 is placed so as to be spaced apart from the nozzle ring 103 in the axial direction. The flow passage 31 is formed between the shroud ring 101 and the nozzle ring 103.

The shroud ring 101 has an annular shape that extends in the circumferential direction. The shroud ring 101 is placed coaxially with the turbine impeller 17. The shroud ring 101 includes a main body portion 101a having a thin-plate ring shape. The nozzle ring 103 has an annular shape that extends in the circumferential direction. The nozzle ring 103 is placed coaxially with the turbine impeller 17. The nozzle ring 103 includes a main body portion 103a having a thin-plate ring shape.

The outer diameter of the main body portion 103a of the nozzle ring 103 is approximately equal to the outer diameter of the main body portion 101a of the shroud ring 101. However, the outer diameter of the main body portion 103a of the nozzle ring 103 may be larger than or smaller than the outer diameter of the main body portion 101a of the shroud ring 101. The inner diameter of the main body portion 103a of the nozzle ring 103 is larger than the inner diameter of the main body portion 101a of the shroud ring 101. However, the inner diameter of the main body portion 103a of the nozzle ring 103 may be equal to the inner diameter of the main body portion 101a of the shroud ring 101, or may be smaller than the inner diameter of the main body portion 101a of the shroud ring 101.

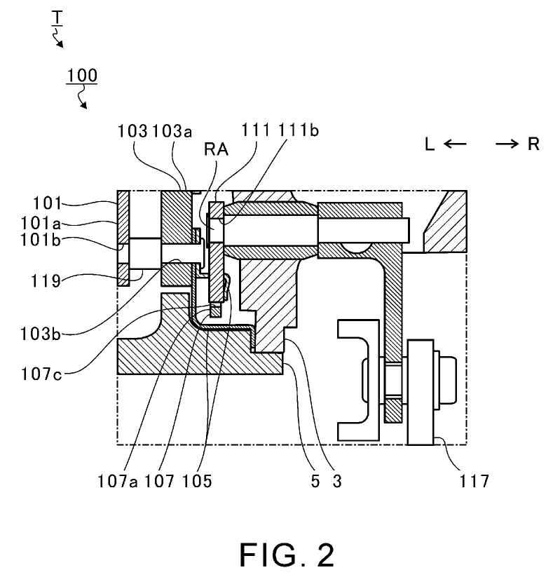

FIG. 2 is a view of a first region R1 extracted from FIG. 1. As illustrated in FIG. 2, a plurality of pin shaft holes 101b are formed in the main body portion 101a of the shroud ring 101. Each pin shaft hole 101b penetrates the main body portion 101a in the axial direction. The plurality of pin shaft holes 101b are formed to be spaced apart from each other in the circumferential direction. For example, the plurality of pin shaft holes 101b are formed at equal intervals in the circumferential direction. However, the plurality of pin shaft holes 101b may be formed at unequal intervals in the circumferential direction.

A plurality of pin shaft holes 103b are formed in the main body portion 103a of the nozzle ring 103. Each pin shaft hole 103b penetrates the main body portion 103a in the axial direction. The plurality of pin shaft holes 103b are formed to be spaced apart from each other in the circumferential direction. For example, the plurality of pin shaft holes 103b are formed at equal intervals in the circumferential direction. However, the plurality of pin shaft holes 103b may be formed at unequal intervals in the circumferential direction.

The number of the pin shaft holes 101b matches the number of the pin shaft holes 103b. Each pin shaft hole 101b is opposed to each pin shaft hole 103b in the axial direction. That is, each pin shaft hole 101b is formed coaxially with each pin shaft hole 103b. A coupling pin 119 is inserted into the pin shaft hole 101b and the pin shaft hole 103b. The shroud ring 101 is coupled to the nozzle ring 103 by the coupling pin 119. The distance between the shroud ring 101 and the nozzle ring 103 is kept constant by the coupling pin 119.

The retaining member 105 is placed between the nozzle ring 103 and the bearing housing 3. The retaining member 105 is coupled to the nozzle ring 103 by the coupling pin 119. In the example of FIG. 2, the retaining member 105 includes two ring-shaped thin plates joined to each other. However, the retaining member 105 may include a single ring-shaped thin plate, or may include three or more ring-shaped thin plates joined to each other.

An outer peripheral edge of the retaining member 105 is sandwiched between the turbine housing 5 and the bearing housing 3. The retaining member 105 is held non-rotatably between the turbine housing 5 and the bearing housing 3. The retaining member 105 retains the shroud ring 101 and the nozzle ring 103 non-rotatably. The drive ring 107 is placed between the nozzle ring 103 and the bearing housing 3. The retaining member 105 retains the drive ring 107 so as to be relatively rotatable.

The drive ring 107 has an annular shape that extends in the circumferential direction. The drive ring 107 is placed coaxially with the turbine impeller 17. The drive ring 107 is provided on a side opposite to the plurality of nozzle vanes 113 with respect to the nozzle ring 103. The drive ring 107 is provided so as to be pivotable in conjunction with the plurality of nozzle vanes 113, as described later. The drive ring 107 corresponds to an example of a third annular member provided on a side opposite to the plurality of nozzle vanes 113 with respect to the second annular member.

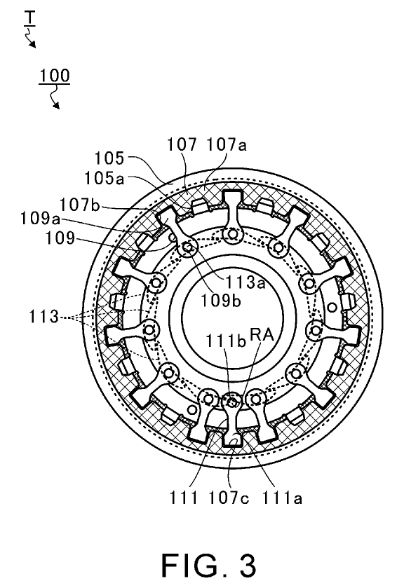

FIG. 3 is a view of the drive ring 107 as viewed from the bearing housing 3 side. As illustrated in FIG. 3, the drive ring 107 includes a main body portion 107a having a thin-plate ring shape. An inner peripheral surface of the main body portion 107a is engaged with an engagement claw 105a of the retaining member 105 so that the main body portion 107a is held so as to be pivotable relative to the retaining member 105. A plurality of transmitting link engagement portions 107b and a link plate engagement portion 107c are formed in the main body portion 107a.

The transmitting link engagement portion 107b is a portion of the main body portion 107a that is cut out from the inner peripheral surface of the main body portion 107a toward the radially outer side. The plurality of transmitting link engagement portions 107b are formed at equal intervals in the circumferential direction of the main body portion 107a. The transmitting link engagement portion 107b is engaged with an engagement end 109a of the transmitting link 109.

The link plate engagement portion 107c is a portion of the main body portion 107a that is cut out from the inner peripheral surface of the main body portion 107a toward the radially outer side. The number of the link plate engagement portions 107c is one. The link plate engagement portion 107c is formed between two transmitting link engagement portions 107b that are adjacent to each other in the circumferential direction. The link plate engagement portion 107c is engaged with an engagement end 111a of the link plate 111.

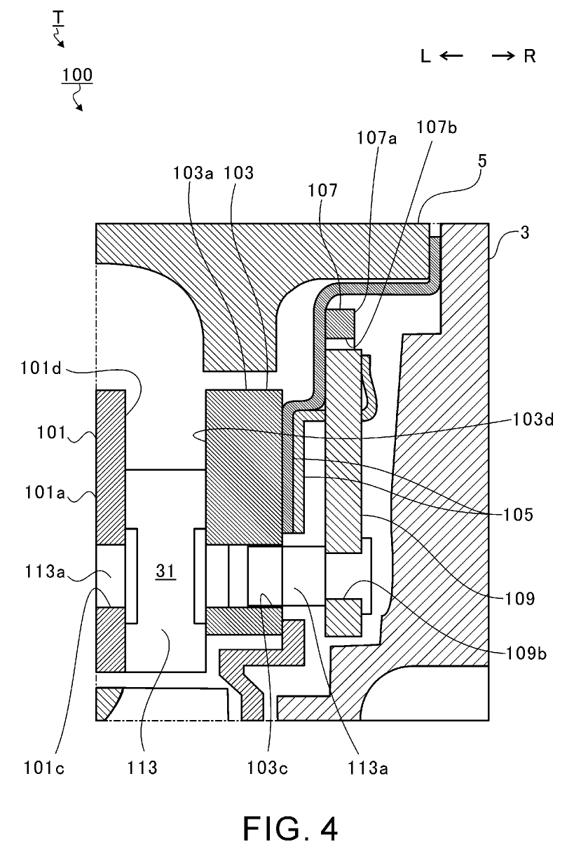

An insertion hole 109b is formed in the transmitting link 109. The insertion hole 109b is formed on a side opposite to the engagement end 109a in the transmitting link 109. As illustrated in FIG. 3 and FIG. 4 to be referred to later, a blade shaft 113a of the nozzle vane 113 is inserted into the insertion hole 109b. The transmitting link 109 is caulked under a state in which the blade shaft 113a of the nozzle vane 113 is inserted into the insertion hole 109b. The transmitting link 109 and the nozzle vane 113 pivot integrally with the blade shaft 113a.

An insertion hole 111b is formed in the link plate 111. The insertion hole 111b is formed on a side opposite to the engagement end 111a in the link plate 111. As illustrated in FIG. 2 and FIG. 3, a pivot shaft RA of the drive mechanism 115 is inserted into the insertion hole 111b. The link plate 111 is caulked under a state in which the pivot shaft RA of the drive mechanism 115 is inserted into the insertion hole 111b. The link plate 111 pivots integrally with the pivot shaft RA of the drive mechanism 115. However, the pivot shaft RA of the drive mechanism 115 may be welded to the insertion hole 111b of the link plate 111.

FIG. 4 is a view of a second region R2 extracted from FIG. 1. As illustrated in FIG. 4, a plurality of blade shaft holes 101c are formed in the main body portion 101a of the shroud ring 101. Each blade shaft hole 101c is formed on a radially inner side with respect to the pin shaft hole 101b in the main body portion 101a. Each blade shaft hole 101c penetrates the main body portion 101a in the axial direction. The plurality of blade shaft holes 101c are formed to be spaced apart from each other in the circumferential direction. Specifically, the plurality of blade shaft holes 101c are formed at equal intervals in the circumferential direction.

A plurality of blade shaft holes 103c are formed in the main body portion 103a of the nozzle ring 103. Each blade shaft hole 103c is formed on the radially inner side with respect to the pin shaft hole 103b in the main body portion 103a. Each blade shaft hole 103c penetrates the main body portion 103a in the axial direction. The plurality of blade shaft holes 103c are formed to be spaced apart from each other in the circumferential direction. Specifically, the plurality of blade shaft holes 103c are formed at equal intervals in the circumferential direction.

The number of the blade shaft holes 103c matches the number of the blade shaft holes 101c. Each blade shaft hole 103c is opposed to each blade shaft hole 101c in the axial direction. That is, each blade shaft hole 103c is formed coaxially with each blade shaft hole 101c. The blade shaft 113a projects in the axial direction from each of surfaces on both sides in the axial direction of each nozzle vane 113. Each blade shaft 113a is inserted into each of the blade shaft hole 101c and the blade shaft hole 103c. Each blade shaft 113a is axially supported in a turnable manner by each of the blade shaft hole 101c and the blade shaft hole 103c.

The plurality of nozzle vanes 113 are placed in the flow passage 31 so as to be spaced apart from each other in the circumferential direction. That is, the plurality of nozzle vanes 113 are placed on the radially outer side with respect to the turbine impeller 17 so as to be spaced apart from each other in the circumferential direction. Specifically, the plurality of nozzle vanes 113 are placed at equal intervals in the circumferential direction. Each nozzle vane 113 is provided so as to be pivotable about a central axis of the blade shaft 113a integrally with the blade shaft 113a. That is, each nozzle vane 113 is provided so as to be pivotable about a pivot axis extending along the axial direction of the turbine impeller 17.

As illustrated in FIG. 1, the actuator 117 is placed outside the turbine housing 5, the bearing housing 3, and the compressor housing 7. The actuator 117 is, for example, a solenoid. The actuator 117 is coupled to the drive mechanism 115. The drive mechanism 115 converts a linear motion of the actuator 117 into a turning motion of the pivot shaft RA.

When the actuator 117 is driven, the pivot shaft RA of the drive mechanism 115 turns. When the pivot shaft RA turns, the link plate 111 pivots about a central axis of the pivot shaft RA integrally with the pivot shaft RA. When the link plate 111 pivots, the link plate engagement portion 107c is pressed in the circumferential direction of the link plate 111, and the drive ring 107 pivots about a central axis of the drive ring 107. When the drive ring 107 pivots, the transmitting link 109 is pressed in the circumferential direction by the transmitting link engagement portion 107b and pivots about a central axis of the insertion hole 109b. When the transmitting link 109 pivots, the blade shaft 113a turns integrally with the transmitting link 109. When the blade shaft 113a turns, the nozzle vane 113 pivots integrally with the blade shaft 113a.

When each nozzle vane 113 pivots, a distance between two nozzle vanes 113 that are adjacent to each other in the circumferential direction changes. When the distance between the two nozzle vanes 113 that are adjacent to each other in the circumferential direction changes, the flow passage cross-sectional area of the flow passage 31 changes. When the flow passage cross-sectional area of the flow passage 31 changes, the flow velocity of the exhaust gas flowing through the flow passage 31 changes.

The variable capacity mechanism 100 changes the distance between the two nozzle vanes 113 that are adjacent to each other in the circumferential direction by causing the plurality of nozzle vanes 113 to pivot in accordance with the flow rate of the exhaust gas. In this manner, an opening degree of the nozzle vane 113 changes. As the extending direction of the nozzle vane 113 comes closer to the circumferential direction of the turbine impeller 17, the distance between the two nozzle vanes 113 that are adjacent to each other in the circumferential direction becomes narrower, and the opening degree of the nozzle vane 113 becomes smaller. In contrast, as an angle formed by the extending direction of the nozzle vane 113 and the circumferential direction of the turbine impeller 17 becomes larger, the distance between the two nozzle vanes 113 that are adjacent to each other in the circumferential direction becomes wider, and the opening degree of the nozzle vane 113 becomes larger.

The opening degree of the nozzle vane 113 is adjustable within a range having an upper limit and a lower limit. When the nozzle vane 113 is fully closed, the extending direction of the nozzle vane 113 is closest to the circumferential direction of the turbine impeller 17, and the opening degree of the nozzle vane 113 becomes minimum. In contrast, when the nozzle vane 113 is fully open, the angle formed by the extending direction of the nozzle vane 113 and the circumferential direction of the turbine impeller 17 becomes largest, and the opening degree of the nozzle vane 113 becomes maximum. As the opening degree of the nozzle vane 113 becomes smaller, the flow passage cross-sectional area of the flow passage 31 becomes smaller.

For example, the variable capacity mechanism 100 reduces the opening degree of the nozzle vane 113 when the flow rate of the exhaust gas is small, thereby increasing the flow velocity of the exhaust gas. In this manner, the variable capacity mechanism 100 can increase the rotation amount of the turbine impeller 17 even when the flow rate of the exhaust gas is small. As a result, the variable capacity mechanism 100 can increase the rotation amount of the compressor impeller 19 even when the flow rate of the exhaust gas is small.

As illustrated in FIG. 4, in the variable capacity mechanism 100, the plurality of nozzle vanes 113 are sandwiched from both sides in the axial direction by the shroud ring 101, which is the first annular member, and the nozzle ring 103, which is the second annular member. A right surface 101d of the shroud ring 101 is opposed to the plurality of nozzle vanes 113. A left surface 103d of the nozzle ring 103 is opposed to the plurality of nozzle vanes 113.

A clearance is interposed between the surface 101d of the shroud ring 101 and the nozzle vane 113. A foreign matter may enter this clearance. A clearance is also interposed between the surface 103d of the nozzle ring 103 and the nozzle vane 113. A foreign matter may also enter this clearance. Examples of the foreign matter include a substance derived from engine oil. A foreign matter that has entered the clearance between the shroud ring 101 or the nozzle ring 103 and the nozzle vane 113 may become a factor that inhibits a smooth operation of the nozzle vane 113.

In this embodiment, a contrivance for removing a foreign matter is applied to at least one of the shroud ring 101 or the nozzle ring 103. In the following, an example in which a contrivance for removing a foreign matter is applied to the shroud ring 101 is described. However, as described later, a similar contrivance may be applied to the nozzle ring 103.

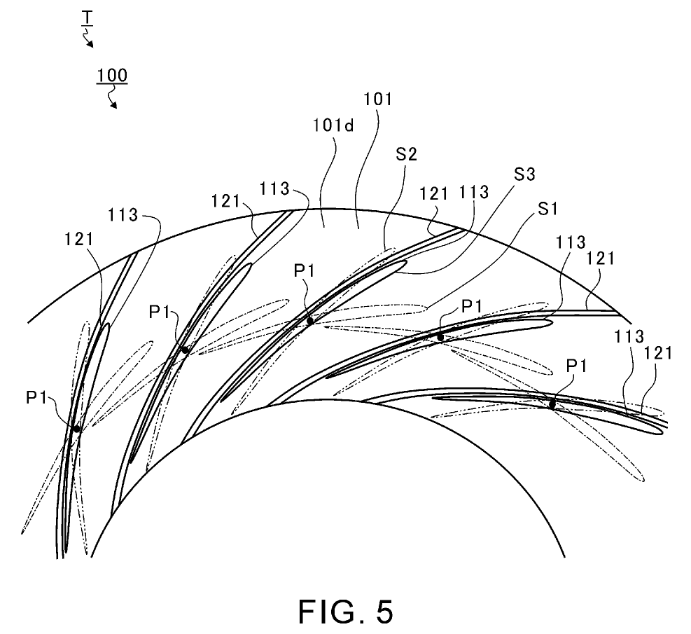

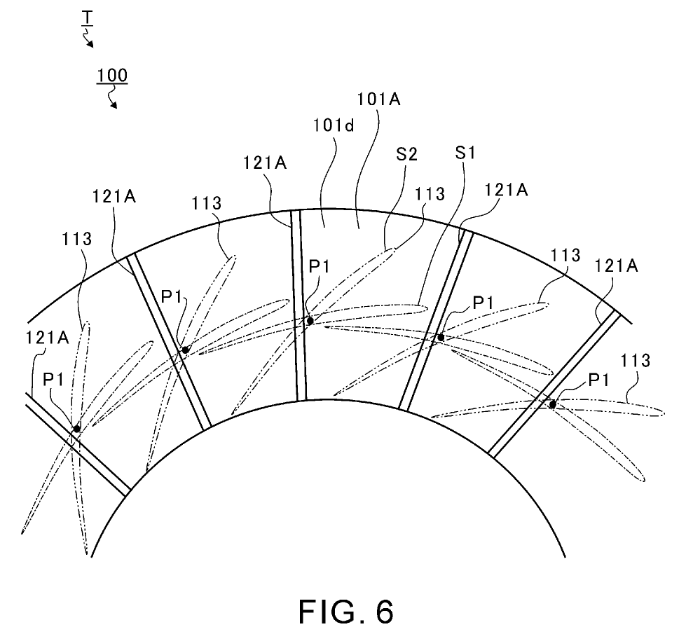

FIG. 5 is a view of the shroud ring 101 in this embodiment as viewed from the bearing housing 3 side. In FIG. 5 and FIG. 6 to be referred to later, the position of the pivot axis of the nozzle vane 113 is indicated by a point P1. Each nozzle vane 113 is pivotable about the point P1. The point P1 corresponding to each nozzle vane 113 is located on a circle concentric with the central axis of the turbine impeller 17.

As described above, the opening degree of the nozzle vane 113 changes as the nozzle vane 113 pivots. FIG. 5 shows a fully closed state S1 in which the opening degree of the nozzle vane 113 is minimum, a fully open state S2 in which the opening degree of the nozzle vane 113 is maximum, and a specific state S3 in which the opening degree of the nozzle vane 113 is a specific opening degree between the minimum value and the maximum value. In the example of FIG. 5, the nozzle vane 113 reaches the specific state S3 by pivoting counterclockwise from the fully closed state S1. In addition, the nozzle vane 113 reaches the fully open state S2 by further pivoting counterclockwise from the specific state S3.

The specific opening degree in the specific state S3 is, for example, an opening degree that is used most frequently among the possible opening degrees of the nozzle vane 113. That is, during operation of the turbocharger TC, the nozzle vane 113 is in the specific state S3 in many situations.

As illustrated in FIG. 5, a plurality of grooves 121 each extending in a direction inclined with respect to the circumferential direction of the turbine impeller 17 are formed in the surface 101d of the shroud ring 101. The plurality of grooves 121 are formed to be spaced apart from each other in the circumferential direction. Specifically, the plurality of grooves 121 are formed at equal intervals in the circumferential direction. Each groove 121 is provided so as to pass near each nozzle vane 113. One groove 121 is provided for one nozzle vane 113. That is, the number of the grooves 121 matches the number of the nozzle vanes 113. However, the number of the grooves 121 may be smaller than or larger than the number of the nozzle vanes 113. The number of the grooves 121 may be one.

A shape of the groove 121 in a cross section orthogonal to the extending direction of the groove 121 is, for example, a rectangle. However, the shape of the groove 121 in the cross section may be other than a rectangle. For example, the shape of the groove 121 in the cross section may be a polygon other than a rectangle, or may be a semicircle.

In the example of FIG. 5, the groove 121 extends from an inner peripheral edge to an outer peripheral edge of the surface 101d of the shroud ring 101. The groove 121 is continuous with an inner peripheral surface of the shroud ring 101 at the inner peripheral edge of the surface 101d. The groove 121 is continuous with an outer peripheral surface of the shroud ring 101 at the outer peripheral edge of the surface 101d.

However, the groove 121 is not required to extend from the inner peripheral edge to the outer peripheral edge of the surface 101d of the shroud ring 101. For example, the groove 121 may extend to the inner peripheral edge of the surface 101d of the shroud ring 101, but may not extend to the outer peripheral edge of the surface 101d and may not be continuous with the outer peripheral surface of the shroud ring 101. For example, the groove 121 may extend to the outer peripheral edge of the surface 101d of the shroud ring 101, but may not extend to the inner peripheral edge of the surface 101d and may not be continuous with the inner peripheral surface of the shroud ring 101. For example, the groove 121 may not extend to the inner peripheral edge of the surface 101d and may not be continuous with the inner peripheral surface of the shroud ring 101, and may not extend to the outer peripheral edge of the surface 101d and may not be continuous with the outer peripheral surface of the shroud ring 101.

In the example of FIG. 5, when viewed in the axial direction of the turbine impeller 17, the groove 121 extends along an outer edge of the nozzle vane 113 when the opening degree of the nozzle vane 113 is the specific opening degree. That is, in the specific state S3, the groove 121 extends along the outer edge of the nozzle vane 113 when viewed in the axial direction of the turbine impeller 17. However, the groove 121 is only required to extend in a direction inclined with respect to the circumferential direction of the turbine impeller 17, and is not limited to the example of FIG. 5.

In the example of FIG. 5, in the specific state S3, the groove 121 does not overlap the nozzle vane 113 and passes near the nozzle vane 113 when viewed in the axial direction of the turbine impeller 17. Specifically, in the specific state S3, the groove 121 extends along an outer edge corresponding to a side surface on the radially outer side of the nozzle vane 113, when viewed in the axial direction of the turbine impeller 17. That is, in the specific state S3, the groove 121 is located on the radially outer side with respect to the nozzle vane 113. However, the groove 121 may extend along an outer edge corresponding to a side surface on the radially inner side of the nozzle vane 113 when viewed in the axial direction of the turbine impeller 17. That is, in the specific state S3, the groove 121 may be located on the radially inner side with respect to the nozzle vane 113.

In the example of FIG. 5, the entire groove 121 has a curved shape. However, a part of the groove 121 may have a linear shape, or the entire groove 121 may have a linear shape. A part of the groove 121 may be bent or curved.

As described above, in the turbine T, at least one groove 121 extending in a direction inclined with respect to the circumferential direction of the turbine impeller 17 is formed in the surface 101d opposed to the plurality of nozzle vanes 113 in the shroud ring 101, which is the first annular member. In this manner, a foreign matter sent to the variable capacity mechanism 100 can be guided to the groove 121, and hence the entrance of the foreign matter into a space between the surface 101d of the shroud ring 101 and the nozzle vane 113 can be suppressed. Further, the variable capacity mechanism 100 can cause the nozzle vane 113 to scrape out and remove the foreign matter guided to the groove 121 by opening and closing the nozzle vane 113. In this manner, the entrance of the foreign matter into the space between the surface 101d of the shroud ring 101 and the nozzle vane 113 can be suppressed more effectively.

In the example of FIG. 5, in the specific state S3, the groove 121 does not overlap the nozzle vane 113 and is located on the radially outer side with respect to the nozzle vane 113, when viewed in the axial direction of the turbine impeller 17. Therefore, the variable capacity mechanism 100 can cause the nozzle vane 113 to scrape out and remove the foreign matter guided to a radially inner part of the groove 121 with respect to the point P1 by causing the nozzle vane 113 to pivot clockwise from the specific state S3. The variable capacity mechanism 100 can cause the nozzle vane 113 to scrape out and remove the foreign matter guided to a radially outer part of the groove 121 with respect to the point P1 by causing the nozzle vane 113 to pivot counterclockwise from the specific state S3. In this manner, the variable capacity mechanism 100 executes removal processing of causing the nozzle vane 113 to scrape out and remove the foreign matter guided to the groove 121 by changing the opening degree of the nozzle vane 113. For example, the variable capacity mechanism 100 may execute the removal processing after the turbocharger TC is stopped.

In the above, an example in which the groove 121 is formed in the shroud ring 101, which is the first annular member, has been described. However, the groove 121 may be formed in the surface 103d opposed to the plurality of nozzle vanes 113 in the nozzle ring 103, which is the second annular member. In this case as well, the foreign matter guided to the groove 121 can be scraped out and removed by the nozzle vane 113 by opening and closing the nozzle vane 113. In this manner, the entrance of the foreign matter into a space between the surface 103d of the nozzle ring 103 and the nozzle vane 113 can be suppressed more effectively. That is, the groove 121 is only required to be formed in the surface opposed to the plurality of nozzle vanes 113 in at least one of the shroud ring 101 or the nozzle ring 103.

The groove 121 may be formed in both of the shroud ring 101 and the nozzle ring 103. The groove 121 may be formed in only one of the shroud ring 101 or the nozzle ring 103.

For example, the groove 121 is formed in at least the shroud ring 101 out of the shroud ring 101, which is the first annular member, and the nozzle ring 103, which is the second annular member. From the viewpoint of improving the efficiency of the turbine T, in some cases, a clearance between the surface 101d of the shroud ring 101 and the nozzle vane 113 is designed to be smaller than a clearance between the surface 103d of the nozzle ring 103 and the nozzle vane 113. In those cases, the foreign matter that has entered the clearance between the surface 101d of the shroud ring 101 and the nozzle vane 113 is more likely to be clogged and less likely to be discharged as compared to the foreign matter that has entered the clearance between the surface 103d of the nozzle ring 103 and the nozzle vane 113. Therefore, with the groove 121 being formed in at least the shroud ring 101, it is possible to more effectively suppress inhibition of a smooth operation of the nozzle vane 113 by the foreign matter sent to the variable capacity mechanism 100.

For example, the groove 121 is formed in at least the nozzle ring 103 out of the shroud ring 101, which is the first annular member, and the nozzle ring 103, which is the second annular member. When the groove 121 is formed in the shroud ring 101, a flow rate of a leakage flow, which is a flow of the exhaust gas leaking through a space between the shroud ring 101 and the nozzle vane 113, increases. When the groove 121 is formed in the nozzle ring 103, a flow rate of a leakage flow, which is a flow of the exhaust gas leaking through a space between the nozzle ring 103 and the nozzle vane 113, increases.

As described above, from the viewpoint of improving the efficiency of the turbine T, in some cases, the clearance between the surface 101d of the shroud ring 101 and the nozzle vane 113 is designed to be smaller than the clearance between the surface 103d of the nozzle ring 103 and the nozzle vane 113. In those cases, an influence of an increase in the flow rate of the leakage flow of the exhaust gas, which is caused by providing the groove 121 in the nozzle ring 103, on a decrease in the efficiency of the turbine T is smaller than an influence of an increase in the flow rate of the leakage flow of the exhaust gas, which is caused by providing the groove 121 in the shroud ring 101, on a decrease in the efficiency of the turbine T. Therefore, with the groove 121 being formed in at least the nozzle ring 103, a decrease in the efficiency of the turbine T can be suppressed more effectively.

In particular, in the turbine T, when viewed in the axial direction of the turbine impeller 17, the groove 121 extends along the outer edge of the nozzle vane 113 when the opening degree of the nozzle vane 113 is the specific opening degree. In this manner, in the specific state S3, a part of the groove 121 can be prevented from being opposed to the nozzle vane 113 in the axial direction. Specifically, in the specific state S3, the groove 121 does not intersect with the nozzle vane 113 when viewed in the axial direction of the turbine impeller 17. Therefore, an increase in the flow rate of the leakage flow, which is a flow of the exhaust gas leaking through a space between the shroud ring 101 and the nozzle vane 113, can be suppressed. Thus, a decrease in the efficiency of the turbine T can be suppressed more effectively.

In particular, in the turbine T, the groove 121 extends from the inner peripheral edge to the outer peripheral edge of the surface 101d of the shroud ring 101. In this manner, the foreign matter guided to the groove 121 can be effectively removed along the groove 121. For example, when the groove 121 does not extend from the inner peripheral edge to the outer peripheral edge of the surface 101d of the shroud ring 101, a step is formed at an end portion of the groove 121. In this case, the removal of the foreign matter may be inhibited by the step at the end portion of the groove 121. In contrast, when the groove 121 extends from the inner peripheral edge to the outer peripheral edge of the surface 101d of the shroud ring 101, such a step is not formed, and hence the foreign matter can be effectively removed.

FIG. 6 is a view of a shroud ring 101A in a modification example as viewed from the bearing housing 3 side. The modification example is an example in which the shroud ring 101 described above is replaced with the shroud ring 101A in the turbine T. In the modification example, a path of a groove 121A formed in the shroud ring 101A is different from the path of the groove 121 in the example of FIG. 5 described above.

As illustrated in FIG. 6, a plurality of grooves 121A extending in a direction inclined with respect to the circumferential direction of the turbine impeller 17 are formed at equal intervals in the circumferential direction in the surface 101d of the shroud ring 101A, similarly to the example of FIG. 5 described above. Each groove 121A is provided so as to pass near each nozzle vane 113. However, the number of the grooves 121A is not limited to that of this example.

In the example of FIG. 6, the groove 121A extends from the inner peripheral edge to the outer peripheral edge of the surface 101d of the shroud ring 101A, similarly to the example of FIG. 5 described above. However, the groove 121A is not required to extend from the inner peripheral edge to the outer peripheral edge of the surface 101d of the shroud ring 101A.

In the example of FIG. 6, unlike the example of FIG. 5 described above, the groove 121A intersects with the nozzle vane 113 regardless of the opening degree of the nozzle vane 113, when viewed in the axial direction of the turbine impeller 17. In any one of the fully closed state S1, the fully open state S2, or a state in which the opening degree of the nozzle vane 113 is an opening degree between the minimum value and the maximum value, the groove 121A crosses the nozzle vane 113 when viewed in the axial direction of the turbine impeller 17. That is, when viewed in the axial direction of the turbine impeller 17, the groove 121A crosses the nozzle vane 113 regardless of the opening degree of the nozzle vane 113.

In the example of FIG. 6, the groove 121A is located in a counterclockwise direction with respect to the point P1 indicating the pivot axis of the nozzle vane 113 that intersects with the groove 121A when viewed in the axial direction of the turbine impeller 17. That is, the groove 121A is opposed in the axial direction to a radially inner part with respect to the point P1 of the nozzle vane 113 that intersects with the groove 121A when viewed in the axial direction of the turbine impeller 17. However, the groove 121A may be located in a clockwise direction with respect to the point P1 indicating the pivot axis of the nozzle vane 113 that intersects with the groove 121A when viewed in the axial direction of the turbine impeller 17. That is, the groove 121A may be opposed in the axial direction to a radially outer part with respect to the point P1 of the nozzle vane 113 that intersects with the groove 121A when viewed in the axial direction of the turbine impeller 17.

In the example of FIG. 6, the entire groove 121A has a linear shape. However, a part of the groove 121A may have a curved shape, or the entire groove 121A may have a curved shape. A part of the groove 121A may be bent or curved.

As described above, in the modification example, similarly to the example of FIG. 5 described above, at least one groove 121A extending in a direction inclined with respect to the circumferential direction of the turbine impeller 17 is formed in the surface 101d opposed to the plurality of nozzle vanes 113 in the shroud ring 101A, which is the first annular member. In this manner, a foreign matter sent to the variable capacity mechanism 100 can be guided to the groove 121A, and hence the entrance of the foreign matter into a space between the surface 101d of the shroud ring 101A and the nozzle vane 113 can be suppressed. Further, the variable capacity mechanism 100 can cause the nozzle vane 113 to scrape out and remove the foreign matter guided to the groove 121A by opening and closing the nozzle vane 113. In this manner, the entrance of the foreign matter into the space between the surface 101d of the shroud ring 101A and the nozzle vane 113 can be suppressed more effectively.

In the example of FIG. 6, when viewed in the axial direction of the turbine impeller 17, the groove 121A crosses the nozzle vane 113 regardless of the opening degree of the nozzle vane 113. During operation of the turbocharger TC, the variable capacity mechanism 100 determines a target opening degree of the nozzle vane 113 based on various pieces of information and controls the opening degree of the nozzle vane 113 to be the target opening degree. In this manner, the foreign matter guided to the groove 121A can be scraped out and removed by the nozzle vane 113. In this way, the variable capacity mechanism 100 executes removal processing of causing the nozzle vane 113 to scrape out and remove the foreign matter guided to the groove 121A by changing the opening degree of the nozzle vane 113.

In the above, an example in which the groove 121A is formed in the shroud ring 101A, which is the first annular member, has been described. However, similarly to the example of FIG. 5 described above, the groove 121A may be formed in the surface 103d opposed to the plurality of nozzle vanes 113 in the nozzle ring 103, which is the second annular member.

In particular, in the modification example, when viewed in the axial direction of the turbine impeller 17, the groove 121A intersects with the nozzle vane 113 regardless of the opening degree of the nozzle vane 113. In this manner, a part of the groove 121A is opposed to the nozzle vane 113 in the axial direction regardless of the opening degree of the nozzle vane 113. Therefore, during operation of the turbocharger TC, when the opening degree of the nozzle vane 113 changes, the foreign matter guided to the groove 121A can be scraped out and removed by the nozzle vane 113. In this manner, the foreign matter can be effectively removed during operation of the turbocharger TC.

Although the embodiment of the present disclosure has been described above with reference to the attached drawings, needless to say, the present disclosure is not limited to the above-mentioned embodiment. It is obvious that a person skilled in the art can arrive at various alterations or modifications within the scope of claims, and it is naturally understood that those examples also belong to the technical scope of the present disclosure.

In the above, the example in which the turbine T is mounted on the turbocharger TC has been described. However, a device on which the turbine T is mounted may be a device other than the turbocharger TC.

WHAT IS CLAIMED IS:

1. A turbine, comprising:
a turbine impeller;
a plurality of nozzle vanes that are placed on a radially outer side with respect to the turbine impeller so as to be spaced apart from each other in a circumferential direction of the turbine impeller, and are each provided so as to be pivotable about a pivot axis extending along an axial direction of the turbine impeller;
a first annular member and a second annular member that extend in the circumferential direction and sandwich the plurality of nozzle vanes from both sides in the axial direction; and
at least one groove that is formed in a surface opposed to the plurality of nozzle vanes in at least one of the first annular member or the second annular member, and extends in a direction inclined with respect to the circumferential direction.

2. The turbine according to claim 1, wherein, when viewed in the axial direction, the at least one groove extends along an outer edge of a corresponding one of the plurality of nozzle vanes when an opening degree of the corresponding one of the plurality of nozzle vanes is a specific opening degree.

3. The turbine according to claim 1, wherein, when viewed in the axial direction, the at least one groove intersects with a corresponding one of the plurality of nozzle vanes regardless of an opening degree of the corresponding one of the plurality of nozzle vanes.

4. The turbine according to claim 1, wherein the at least one groove extends from an inner peripheral edge to an outer peripheral edge of the surface.

5. The turbine according to claim 1, further comprising a third annular member that is provided on a side opposite to the plurality of nozzle vanes with respect to the second annular member, extends in the circumferential direction, and is provided so as to be pivotable in conjunction with the plurality of nozzle vanes,
wherein the at least one groove is formed in at least the first annular member.

6. The turbine according to claim 1, further comprising a third annular member that is provided on a side opposite to the plurality of nozzle vanes with respect to the second annular member, extends in the circumferential direction, and is provided so as to be pivotable in conjunction with the plurality of nozzle vanes,
wherein the at least one groove is formed in at least the second annular member.

7. A turbocharger, comprising the turbine of claim 1.

8. A turbocharger, comprising the turbine of claim 2.

9. A turbocharger, comprising the turbine of claim 3.

10. A turbocharger, comprising the turbine of claim 4.

11. A turbocharger, comprising the turbine of claim 5.

12. A turbocharger, comprising the turbine of claim 6.
